(19) United States
(12) Patent Application Publication
(10) Pub. No.: US 2017/0010860 A1
(43) Pub. Date: Jan. 12, 2017

(54) SYSTEM AND METHOD FOR ENRICHED MULTILAYERED MULTIMEDIA COMMUNICATIONS USING INTERACTIVE ELEMENTS

(71) Applicant: Matthew James Henniger, Peterborough (CA)

(72) Inventor: Matthew James Henniger, Peterborough (CA)

(21) Appl. No.: 15/203,765

(22) Filed: Jul. 6, 2016

Related U.S. Application Data
(60) Provisional application No. 62/189,343, filed on Jul. 7, 2015.

(51) Int. Cl. G06F 3/16; H04L 12/58; H04L 29/06; G06F 3/0484; G10L 15/26

(52) U.S. Cl. CPC G06F 3/167; G06F 3/04847; G10L 15/26; H04L 65/601; H04L 51/04; H04L 67/42

(57) ABSTRACT

A system for enriched multilayered multimedia communications interactive element propagation, comprising an integration server that operates communication interfaces for communication with clients, a dictionary server that stores and provides dictionary words and functional associations, and an account manager that stores user-specific information, and a method for providing enriched multilayered multimedia communications interactive element propagation.

### CROSS-REFERENCE TO RELATED APPLICATIONS

This application claims the benefit of, and priority to, U.S. provisional patent application 62/189,343 titled, “SYSTEM AND METHOD FOR USER-GENERATED MULTILAYERED COMMUNICATIONS ASSOCIATED WITH TEXT KEYWORDS”, filed on Jul. 7, 2015, the entire specification of which is incorporated herein by reference.

### BACKGROUND OF THE INVENTION

Field of the Art

The disclosure relates to the field of network communications, and more particularly to the field of enhancing communications using multimedia.

Discussion of the State of the Art

In the art of social networking, a large quantity of text-based content is created and redistributed by users on a daily basis. These postings may contain a wide variety of words, phrases, jargon or lingo, emoticons or other images, or other media content such as embedded audio or video data. There is an increasing interest in connecting online activity to real-world activities, such as the rapidly-growing market of connected devices and the “Internet of Things”. However, currently there is very limited functionality to automatically link these online posting to the connected, physical world. Users generally must take manual action to interact with their connected devices or to trigger events within a social network or other communication context (such as sending messages or media files to other users).

What is needed, is a means to automatically associate text-based key words or phrases with functional associations that may be used to direct specific actions, processes, or functions in network-connected software applications or hardware devices, and a means for users to curate their functional associations and administer their operation.

### SUMMARY OF THE INVENTION

Accordingly, the inventor has conceived and reduced to practice, in a preferred embodiment of the invention, a system and method for enriched multilayered multimedia communications interactive element propagation.

According to a preferred embodiment of the invention, a system for enriched multilayered multimedia communications interactive element propagation, comprising an integration server comprising a plurality of programming instructions stored in a memory and operating on a processor of a network-connected computing device, and configured to operate a plurality of software or hardware-based communication interfaces to facilitate two-way communication with a plurality of clients via a network; a dictionary server comprising a plurality of programming instructions stored in a memory and operating on a processor of a network-connected computing device, and configured to store and provide at least a plurality of dictionary words stored by users and a plurality of functional associations, the functional associations comprising at least a plurality of programming instructions configured to produce an effect within or upon a software application or hardware device, and further configured to direct an integration server to send at least a portion of the plurality of functional associations to at least a portion of the plurality of clients; and an account manager comprising a plurality of programming instructions stored in a memory and operating on a processor of a network-connected computing device, and configured to store user-specific information such as contact or personal identification information, is disclosed.

According to another preferred embodiment of the invention, a method for providing enriched multilayered multimedia communications interactive element propagation, comprising the steps of configuring, at a dictionary server comprising a plurality of programming instructions stored in a memory and operating on a processor of a network-connected computing device, and configured to store and provide at least a plurality of dictionary words stored by users and a plurality of functional associations, the functional associations comprising at least a plurality of programming instructions configured to produce an effect within or upon a software application or hardware device, and further configured to direct an integration server to send at least a portion of the plurality of functional associations to at least a portion of the plurality of clients, a plurality of dictionary words; configuring a plurality of functional associations; linking at least a portion of the plurality of dictionary words with at least a portion of the plurality of functional associations; receiving, at an integration server comprising a plurality of programming instructions stored in a memory and operating on a processor of a network-connected computing device, and configured to operate a plurality of software or hardware-based communication interfaces to facilitate two-way communication with a plurality of clients via a network, a plurality of user activity information from a client via a network; identifying a plurality of dictionary words within at least a portion of the plurality of user activity information; and sending at least a functional association to the client via a network, the functional association being selected based at least in part on a configured link between the functional association and at least a portion of the plurality of identified dictionary words, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary system architecture for providing enriched multilayered multimedia communications interactive element propagation, according to a preferred embodiment of the invention.

FIG. 6 is a flow diagram illustrating an exemplary method overview for configuring interactive elements in an enriched multilayered multimedia communication environment, according to a preferred embodiment of the invention.

FIG. 7 is a block diagram of an exemplary architectural overview of a system arrangement utilizing internet-of-things devices.

FIG. 8 is an illustration of an exemplary embodiment of a resultant image from tapping on the user interface comprising an interactive element to define a new layer of content for communication.

FIG. 9 is an illustration of an exemplary embodiment of a resultant image from tapping on the user interface comprising an interactive element to define a new layer of content for communication.

FIG. 10 is an illustration of an exemplary embodiment of a resultant image from tapping on the user interface comprising an interactive element to define a new layer of content for communication.

FIG. 11 is an illustration of an exemplary embodiment of a resultant image from tapping on the user interface comprising an interactive element to define a new layer of content for communication.

FIG. 12 is a block diagram illustrating an exemplary system architecture for configuring and displaying enriched multilayered multimedia communications using interactive elements, according to a preferred embodiment of the invention.

FIG. 13 is an illustration of an exemplary interaction comprising an interactive element in enriched multilayered multimedia communication, according to a preferred embodiment of the invention.

FIG. 14 is an illustration of an exemplary processing of interactive elements in an enriched multilayered multimedia communications environment, according to a preferred embodiment of the invention.

FIG. 15 is an illustration of an exemplary configuration of interactive elements in an enriched multilayered multimedia communications environment, according to a preferred embodiment of the invention.

FIG. 16A is an illustration of an exemplary configuration of a software interface for selecting and assigning interactive elements using a text search query, according to a preferred embodiment of the invention.

FIG. 16B is a further illustration of an exemplary configuration of a software interface for selecting and assigning interactive elements using audio input, according to a preferred embodiment of the invention.

FIG. 16C is a further illustration of an exemplary configuration of a software interface for selecting and assigning interactive elements using a radial menu interface, according to a preferred embodiment of the invention.

### DETAILED DESCRIPTION

The inventor has conceived, and reduced to practice, in a preferred embodiment of the invention, a system and method for enriched multilayered multimedia communications interactive element propagation.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

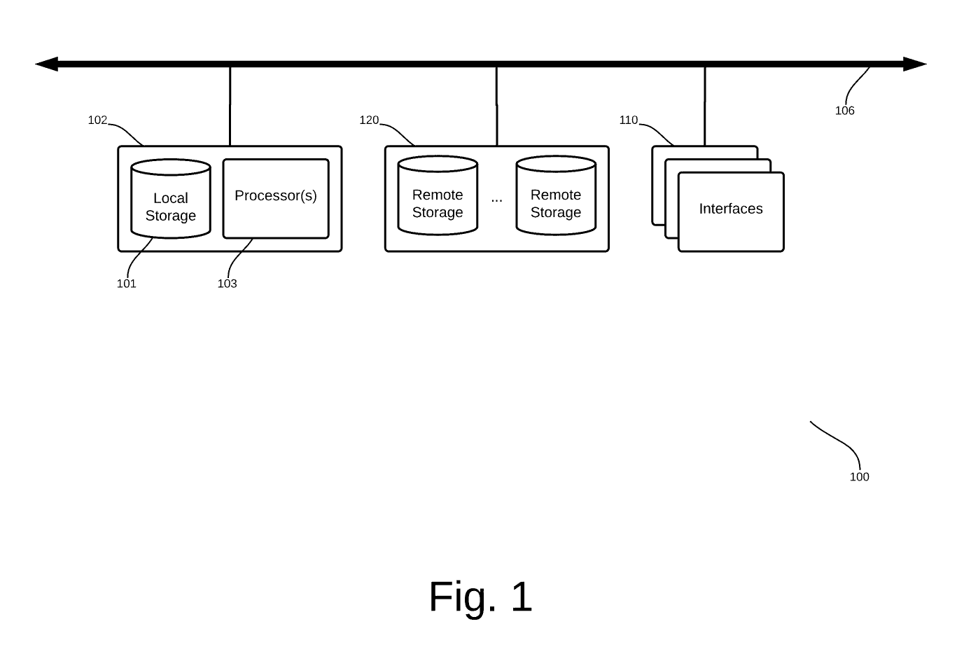

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic Tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

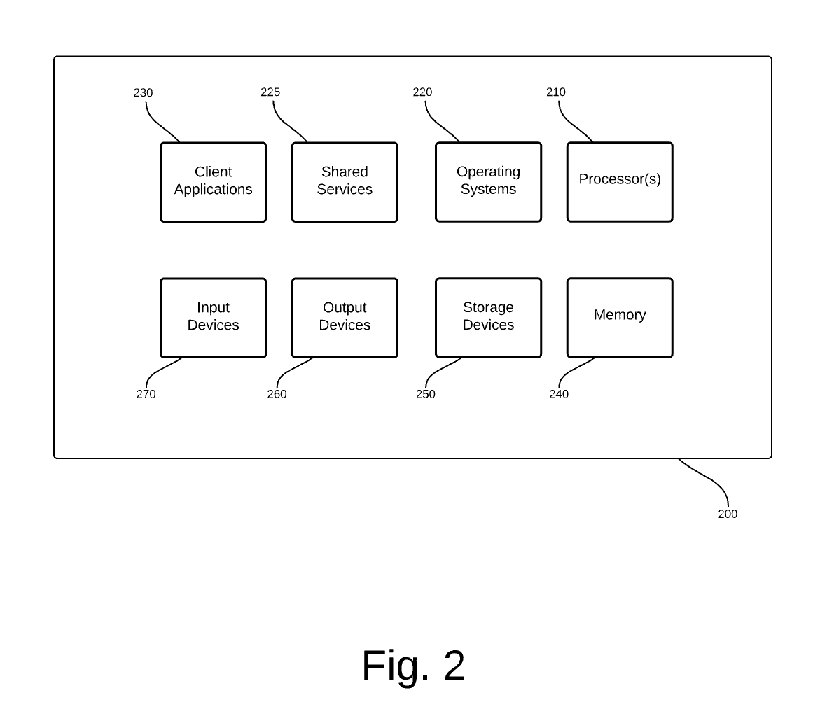

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

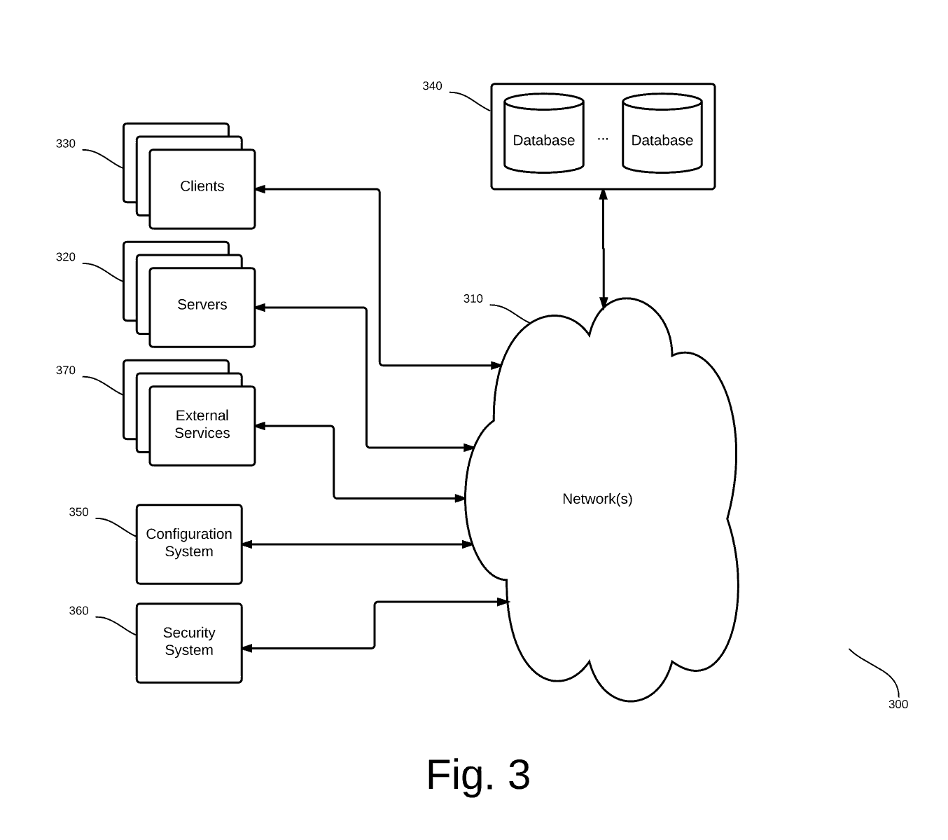

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

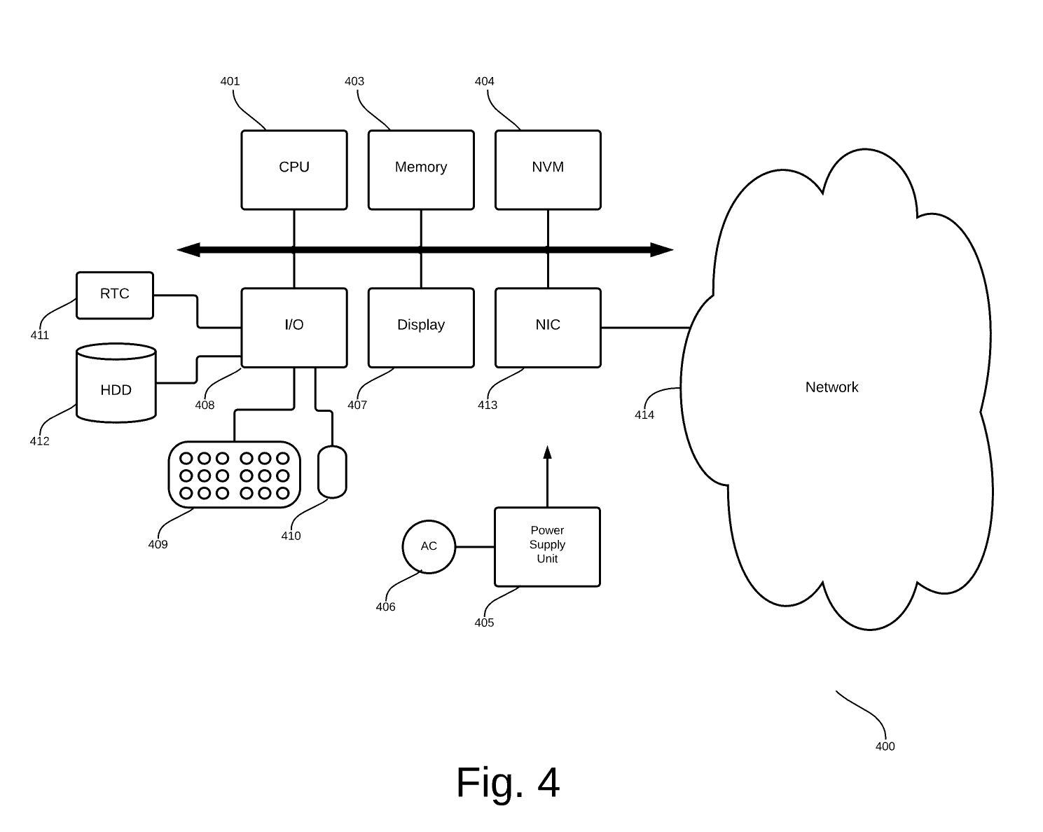

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

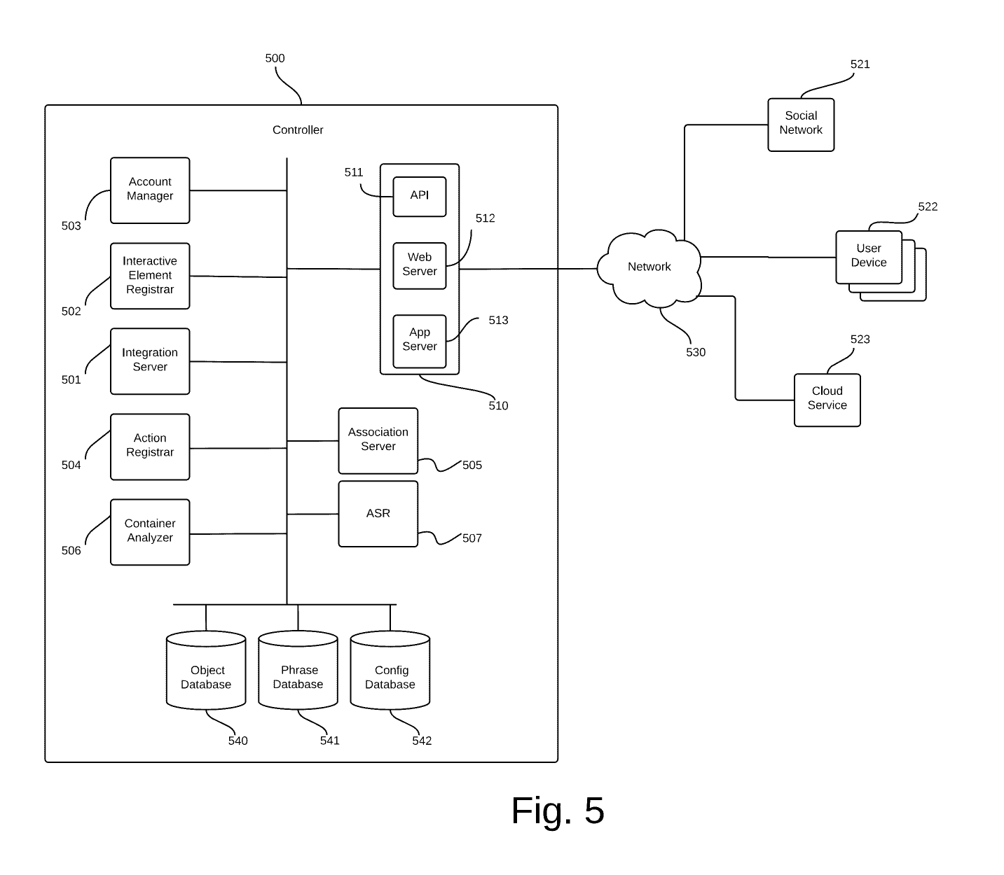

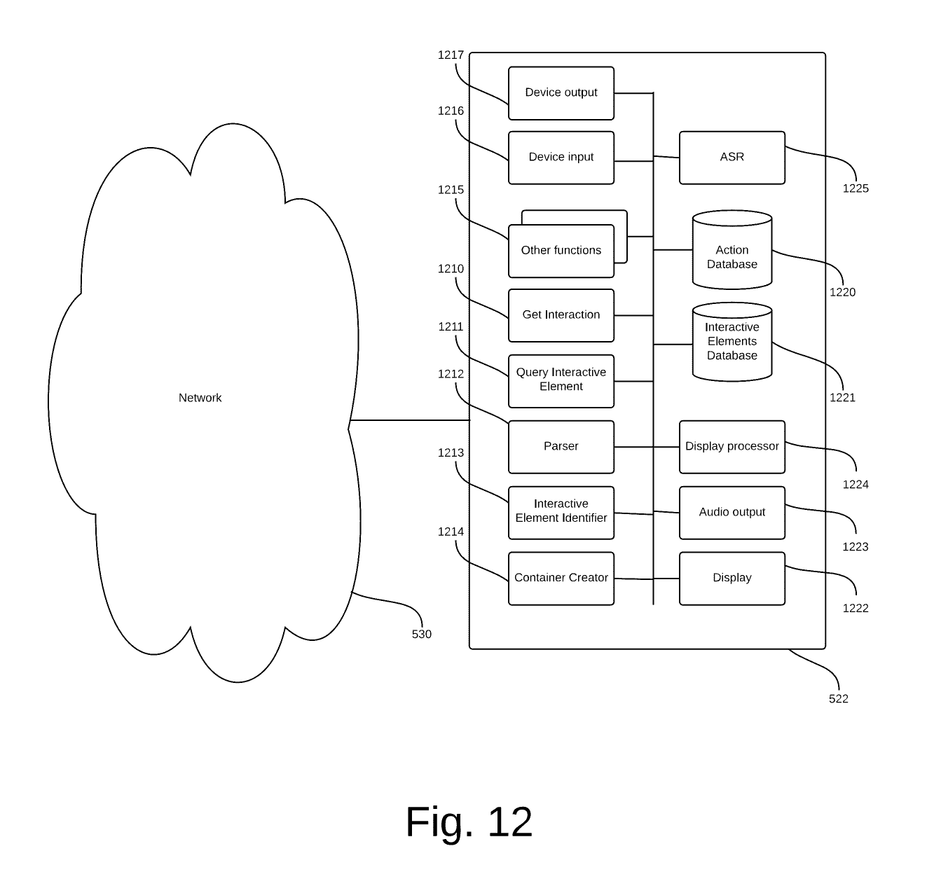

FIG. 5 is a block diagram illustrating an exemplary system architecture 500 for providing enriched multilayered multimedia communications interactive element propagation, according to a preferred embodiment of the invention. According to the embodiment, a system 500 may comprise an integration server 501 comprising a plurality of programming instructions stored in a memory and operating on a processor of a network-connected computing device, and configured to operate a plurality of software or hardware-based communication interfaces 510 to facilitate two-way communication with various network-connected software applications or devices via a network 530. For example, a software application programming interface (API) 511 may be used to communicate with a social networking service 521 or a software application 523 operating via the cloud or in a software-as-a-service (SaaS) manner, such as IFTTT™. A web server 512 may be used to communicate with a web-based interface accessible by a user via a web browser operating on device 522 (described in greater detail below, referring to FIG. 12) such as a personal computer, a mobile device such as a tablet or smartphone, or a specially programmed user device. An application server 513 may be used to communicate with a software application operating on a user's device such as an app on a smartphone.

Further according to the embodiment, interactive element registrar 502 may be utilized, and may comprise a plurality of programming instructions stored in a memory and operating on a processor of a network-connected computing device, and configured to store and provide a plurality of interactive elements, for example, a text string comprising dictionary words configured by a first user device 522 and a plurality of functional associations associated by association server 505 comprising software instructions configured to produce an effect in second user device 522, a social network 521, a network-connected software application, or another computer interface. For example, a user, via a first user device 522, may configure an interactive element (which may be, for example, a word in the user's language, a foreign word, or an arbitrarily-created artificial word of their own creation) using a first user device 522 whereby interface 510 receives the configured interactive element, passes it to interactive element registrar 502 whereby an interactive element identifier is assigned and is stored in phrase database 541. First user device 522 may then configure an action (for example, an animation, sound, video, image, etc.) and send it to interface 510 through network 530. The action is then passed to action registrar 504 whereby an action identifier is assigned and the action is stored in object database 540. A functional association between the interactive element identifier and the action identifier. The action identifier is stored with the associated interactive element identifier record in the phrase database and the interactive element identifier is updated in the associated object database 540. It should be appreciated that, in some embodiments, a plurality of actions can be associated to a single interactive element, and a plurality of interactive elements can be associated to a single action.

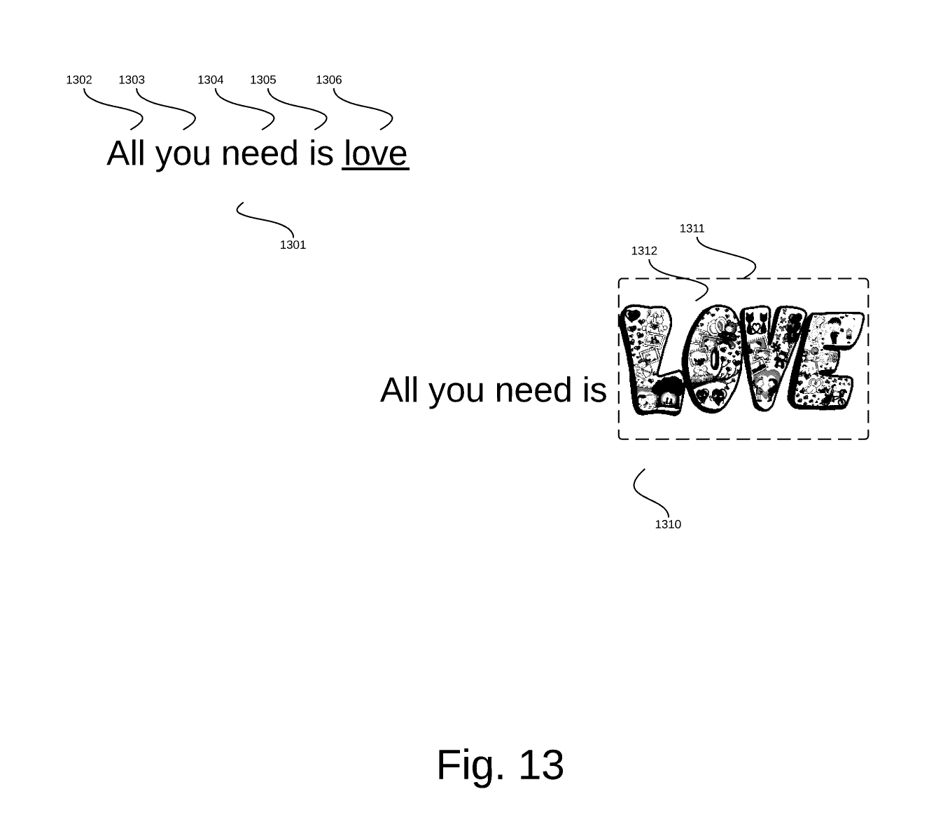

Further according to the embodiment, container analyzer 506 may be utilized, and may comprise a plurality of programming instructions stored in a memory and operating on a processor of a network-connected computing device, and configured to receive additional information from first user device 522 detailing the dynamics of the action. For example, the size of a container for an image, animation and/or video (i.e. the area of a screen where the image, animation or video will appear) wherein the additional information is a specification describing how different actions will present on a plurality of client devices 522, for example, the size of the container, border style, how to handle surrounding elements, for example, separate text (as described in FIG. 13). It should be appreciated that different proportions may be dynamically calculated for specific characteristics of a target client device 522. For example, if a second client device 522 had a screen size of 10 cm, an appropriately-sized container may be used, for example to accommodate an entire message and include any associated action in a way where it can be easily viewed by second client device 522 to maintain readability. In another example, where a screen size of third client device 522 is 58 cm, a larger container may be larger in size. Once all actions are registered and characteristics of actions are received by container analyzer 506, characteristics are associated to the corresponding action identifier and stored in object database 540.

Further according to the embodiment, an account manager 503 may be utilized, and may comprise a plurality of programming instructions stored in a memory and operating on a processor of a network-connected computing device, and configured to store user-specific information such as contact or personal identification information. User-specific information may be used to enforce user account boundaries, preventing users from modifying others' dictionary information, as well as enforcing user associations such as social network followers, ensuring that users who may not be participating in enriched multilayered multimedia communications interactive element propagation will not be adversely affected (for example, preventing interactive elements from taking actions on a non-participating user's device). In some embodiments, content preferences may be set for a dictionary (for example, what content, actions, or data associated with actions users may rate well, or may use more often, or may correspond to particular tags or are of a certain category such as humor, street, etc.). In some embodiments, demographics of a user, including possibly what actions and associations the user has already used from the dictionary site, and what the user may have shared with other users may be used to decide on which dictionary item to access for a particular action or interactive element. In some embodiment, feedback or comments may be attached to interactive elements or data associated to an interactive element, or both.

According to the embodiment, a number of data stores such as software-based databases or hardware-based storage media may be utilized to store and provide a plurality of information for use, such as including (but not limited to) storing user-specific information such as user accounts in configuration database 542, storing dictionary information such as interactive elements, or functional associations, in phrase database 541, and storing objects associated to functions, and associated interactive elements in object database 540, and the like.

In some embodiments, interactive elements may include association decided by community definitions (for example, as decided or voted by a plurality of user devices). For example, a plurality of user devices may vote to decide a particular definition associated to an interactive element. For example, in some embodiments, the definition with the highest votes appear.

In some embodiments, an interactive element may be associated to a hashtag.

In some embodiments, a function may be associated to an interactive element, for example, a time stamped item that may allow user devices to view content that user devices send in a predefined period, or communications, associations, and the like, that may be viewed by time, or which user device sent them.

FIG. 12 is a block diagram illustrating an exemplary system architecture for configuring and displaying enriched multilayered multimedia communications using interactive elements, according to a preferred embodiment of the invention. According to the embodiment, user device 522 may be a personal computer, a mobile device such as a tablet or smartphone, a specially programmed user device computer or the like comprising a plurality of programming instructions stored in a memory and operating on a processor of a network-connected computing device, and configured to display enriched multilayered multimedia communications using interactive elements.

In a preferred embodiment of the invention, get interaction 1210 may comprise a plurality of programming instructions configured to receive a plurality of interactions from interactive element registrar 502 via communication interfaces 510 to facilitate enriched multilayered communications that may contain a plurality of interactive elements. According to the embodiment, an interaction may comprise a plurality of alpha-numeric characters comprising a message (for example, a word or a phrase) that may have previously originated from a plurality of other user devices 522. According to the embodiment, any interactive element present in the interaction may be presented via an embed code comprising an identifier to identify it as an interactive element. Included in the identifier may be an interactive element identifier. It should be appreciated that interactions received by get interactions 1210 may represent historic, real-time, or near real-time communications. In some embodiments get interaction may receive interactions that may have originated by connected social media platforms connected via app server 513.

In another embodiment, get interaction 1210 monitors interactions of device 522, for example, an interaction is inputted into user device 522 via input mechanisms available through device input 1216, for example, a soft keyboard, a hardware connected keyboard such as a keyboard built into the device or connected via a wireless protocol such as Bluetooth™, RF, or the like, a microphone, or some other input mechanism known in the art. In the case input via microphone, device input may perform automatic speech recognition (ASR) to convert audio input to text input to be processed as an interaction as follows.

In a preferred embodiment, parser 1212 may comprise a plurality of programming instructions configured to receive the interaction as input, for example, in the form of sequential source program instructions, interactive online commands, markup tags, or some other defined interface and break the interaction up into parts (for example, words or phrases, interactive elements, and their attributes and/or options) that may be then be managed by interactive element identifier 1213 comprising programming instructions configured to identify a plurality of interactive elements. In some embodiments, parser 1212 may check to see that all required elements to process enriched multilayered multimedia communications using interactive elements have been received. Once one or more interactive elements are identified, they are marked and stored in interactive elements database 1221 with all associated attributes. Once parser 1212 has completed parsing the interaction in its entirety and all interactive elements are identified, query interactive elements 1211 may request a plurality of associated actions from object database 540 via action registrar 504 via network 530 via interfaces 510. Any received actions are then stored in action database 1220 including any associated attributes (for example, image files, video files, audio files, and/or the like). In some embodiments action database 1220 may request all configured actions from object database 540 via action registrar 504 via network 530 via interfaces 510 when user device 522 commences operation. In this regard, query interactive element 1211 may only periodically request or receive new or modified actions during the operation of user device 522.

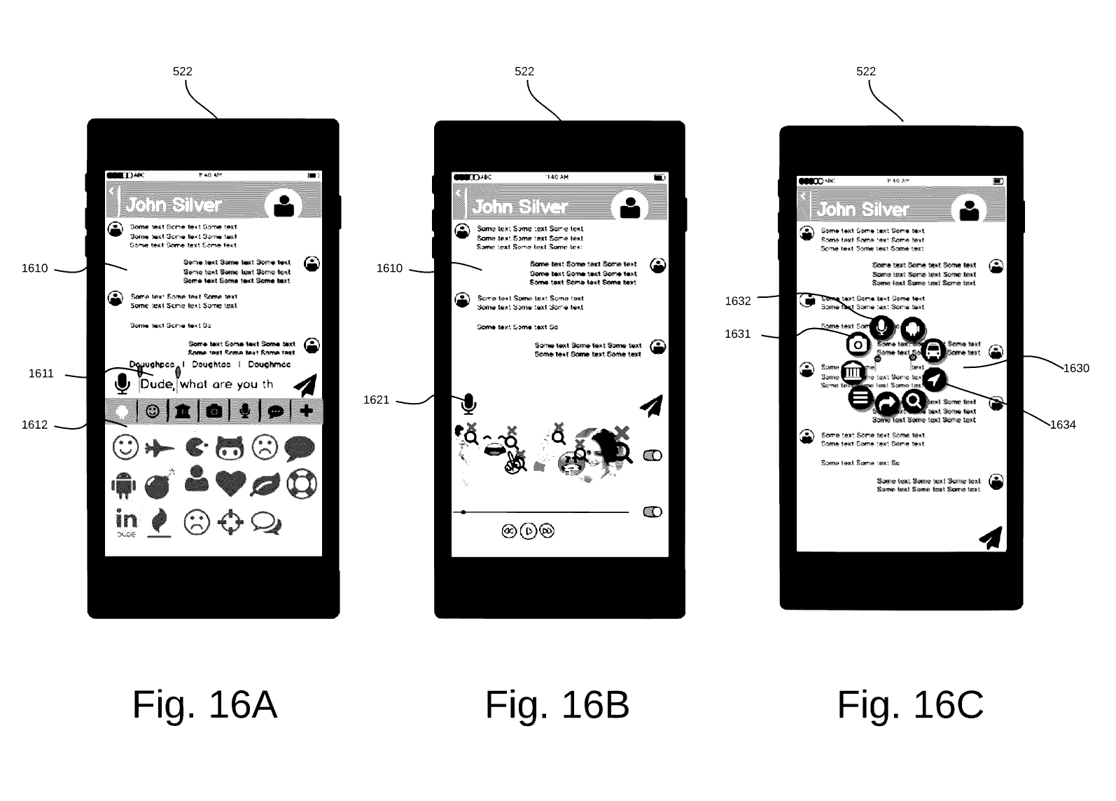

In a preferred embodiment, container creator 1214 may comprise a plurality of programming instructions configured to determine how actions will be displayed on display 1222. For example, an interaction where a plurality of alphanumeric characters within the interaction (as parsed by parser 1212) have been identified to be an interactive element with an associated action. In this regard, container creator 1214 may create a container to contain an element or attribute of the associated action, for example, where the action may be “replace the interactive element with an image file”, container creator 1214 may create a container to hold the associated image file. In this regard, display processor 1224 may compute a resultant image taking into account the interaction and performing the required actions for each interactive element as discovered by parser 1212. According to the embodiment, the interactive element will be replaced by an image container containing the associated image file (as described in FIG. 16). In another embodiment, the action may be to play an associated video file. In this regard, the container will contain programming instructions to play the video file in place of the interactive element. In another embodiment, the action may be to display a background image of display 1222 of device 522. In this regard, the interactive element may not be changed and container creator 1214 access and updates a background image of display 1222 of device 522. In another embodiment, an action associated to the interactive element may be to play an audio file via audio output 1223. In this regard, the container will contain programming instructions to play the audio file to audio output 1223 of user device 522. It should be appreciated that an interaction may contain a plurality of interactive elements with an associated plurality of actions configured to simultaneously, or in series, or in a plurality of combinations, manipulate display 1222, audio output 1223, or other functions 1215 (for example, vibrate function, LED flash, camera lens, communication function, ring-tone function, etc.) available on user device 522. In some embodiments, background images of display 1222 may change as a result of words recognized in a communication between a plurality of user devices 522

In some embodiments, actions are not automatically performed to display 1222. In this regard, indicia may be provided to enable a viewer to interact with the interactive element to commence an associated action. In this regard, once device 522 received input from a user (for example via a touch-sensitive screen), interacting with the interactive element, the action may be performed as previously described.

In some embodiments, an interactive element may not have indicia that identify it as an interactive element. In this regard, each parsed element, as parsed by parser 1212, may be used to determine if the element has been previously configured. or registered, as an interactive element. In this regard, a request is submitted to query interactive element 1211 to determine if any actions and/or attributes are associated to the element. In this regard, query interactive element 1211 may query interactive elements database 1221 to determine if it is an interactive element. If so, associated actions and attributes are retrieved from action database 1220 or requested from object database 540 via network 530. For example, if the element “LOL” is parsed as an element by parser 1212, a lookup element “LOL” may commence on interactive elements database 1221. It should be appreciated that any special-purpose programming language known in the art (for example, SQL) may be used to perform database lookups. If it is determined that element “LOL” is indeed an interactive element, a request is made to action database 1220. In this example, an action to expand the acronym “LOL” to “Laugh out Loud” may be configured and performed by container creator 1214 to accommodate the increase is display size of the message, and display processor 1224 to compute the resultant display message and the words “Laugh out Loud” may be displayed on display 1222 instead of the acronym “LOL”.

In another embodiment, interactive elements may be identified from audio input via device input 1216. In this regard, each input of audio is automatically recognized using automatic speech recognition (ASR) 1225 which may contain ASR algorithms known in the art (for example, Nuance™). In this regard, audio input from device input 1216 is recognized by ASR 1225 and converted to text. Parser 1212 then identifies each element and performs a lookup to interactive elements database 1221. When an interactive element is identified, an associated action is retrieved from action database 1220 and the action is performed. For example, parser 1212 has identified element “I won” from ASR 1225 from voice data inputted via device input 1216. The element “I won” has been determined to be an interactive element by query interactive element 1211. Associated actions are retrieved from action database 1220. In this example, the associated action is to play an audio file (for example, an audio file with people cheering) to device output 1217. For example, if user device 522 was a mobile communication device, in this example, while a conversation between two users is taking place, when a participant utters, “I won” and audio file of people cheering would play within the communication stream thereby enriched communications in a multilayered multimedia fashion using interactive elements.

### Detailed Description of Exemplar), Embodiments

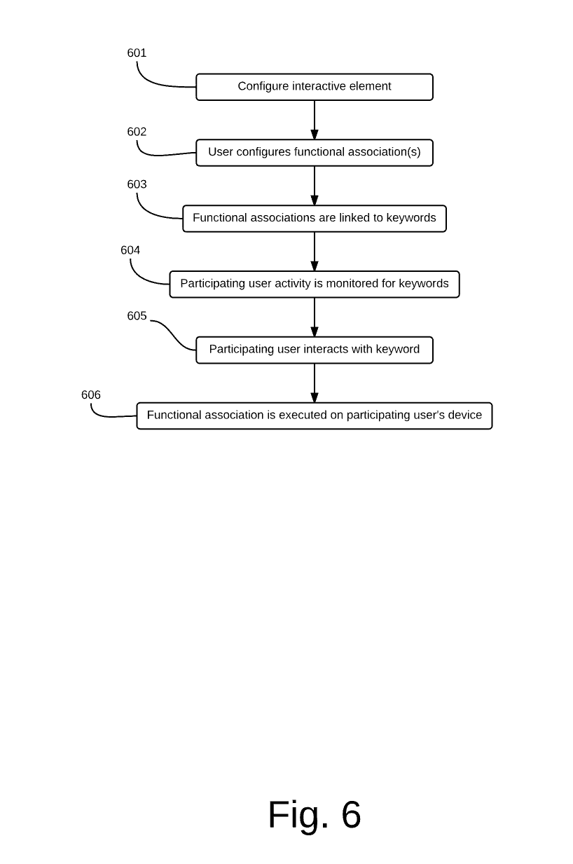

FIG. 6 is a flow diagram illustrating an exemplary method overview for configuring interactive elements in an enriched multilayered multimedia communication environment, according to a preferred embodiment of the invention. In an initial step 601, A user, via a user device, may configure a plurality of interactive elements, for example including actual words in the user's language, words in another language, or “artificial” words of a user's own creation (for example, a “word” may be any string of alphanumeric characters, or may incorporate punctuation, diacritical marks, or other characters that may be reproduced electronically, such as using the Unicode font encoding standard). It should also be appreciated that while the term “word” may be used, a dictionary keyword may in fact appear to consist of more than one word, for example an interactive element containing whitespace or punctuation.

In a next step 602, A user, via user device 522, may configure a plurality of functional associations i.e. actions, for example by writing program code configured to direct a device or application to perform a desired operation, or through the use of any of a variety of suitable simplified interfaces or “pseudocoele” means to produce a desired effect. In a next step 603, actions may be associated to one or more interactive elements, generally in a 1:1 correlation, however, alternate arrangements may be utilized according to the invention, for example a single interactive element that may be associated with multiple functional associations to produce more complex operations such as conditional or loop operations, or variable operation based on variables or subsets of text. For example, when the text “kitchen lights” is found, an action may be triggered that specifically targets a connected lightbulb identified as “kitchen”, while the string “bathroom lights” may trigger an action specific to a connected light fixture identified as “bathroom”, or other such uses according to a particular arrangement. In other embodiments, actions may describe a process to display images, play an audio file, play a video file, enable a vibrate function, enable a light emitting diode function (or other light), etc. of user device 522.

In a next step 604, activity of a participating user (for example, a user that has configured an account with an enriched interactive element system as described above, referring to FIG. 5) may be monitored for interactive elements, such as checking any text-based content displayed within an application or web page on a user's device. For example, if a participating user is viewing a social media posting, the text content of the posting may be checked for interactive elements. Additionally, according to a particular arrangement, a user's activity may only be monitored for a particular subset of known interactive elements, for example to enable users to “subscribe” to “collections” of interactive elements to tailor their experience to their preference, or to only check for interactive elements that were configured by a social network user account the participating user follows, for example.

In a next step 605, a participating user may interact with an interactive element on their device. Such interaction may be any of a variety of deliberate or passive action on the user's part, and may optionally be configurable by either the participating user (such as in an account configuration for their participation in an enhanced interactive element system) or by the user who created the particular interactive element, or both. For example, A user, via a user device, maybe considered to have “interacted” with an interactive element upon viewing, or a more deliberate action may be required such as “clicking” on an interactive element with a computer mouse, or “tapping” on an interactive element on a touchscreen-enabled device. Additionally, a user's activity may be tracked to determine whether they are producing, rather than viewing, an interactive element, for example typing an interactive element into a text field on a web page, using an interactive element in a search query, or entering an interactive element in a computer interface. It should be appreciated that various combinations of functionality may be utilized according to the embodiment, for example using some interactive elements that may consider viewing to be an interaction, and some interactive elements that may require deliberate user action. Additionally, an interactive element interaction may be configured to be arbitrarily complex or unique, for example in a gaming arrangement an interactive element may be configured to only “activate” (that is, to register a user interaction) upon the completion of a specific sequence of precise actions, or within a certain timeframe. In this manner, various forms of interactive puzzles or games may be arranged using enhanced interactive elements, for example by hiding interactive elements in sections of ordinary-appearing text, that may only be activated in a specific or obscure way, or interactive elements that may only activated if other interactive elements have already been interacted with.

In a final step 606, upon interaction with an interactive element any linked functional associations may be executed on a user's device. For example, if an interactive element has a functional association directing their device to display an image, the image may be displayed after the user clicks on the interactive element. Functional associations may have a wide variety of effects, and it should be appreciated that while a particular functional association may be executed on a user's device (that is, the programming instructions are executed by a processor operating on the user's device), the visible or other results of execution may occur elsewhere (for example, if the functional association directs a user's device to send a message via the network). In this manner, the execution of a functional association may take place on a user's device where they are interacting with interactive elements, ensuring that an unattended device does not take action without a user's consent, while also providing expanded functionality according to the capabilities of the user's particular device (such as network or specific hardware capabilities that may be utilized by a functional association).

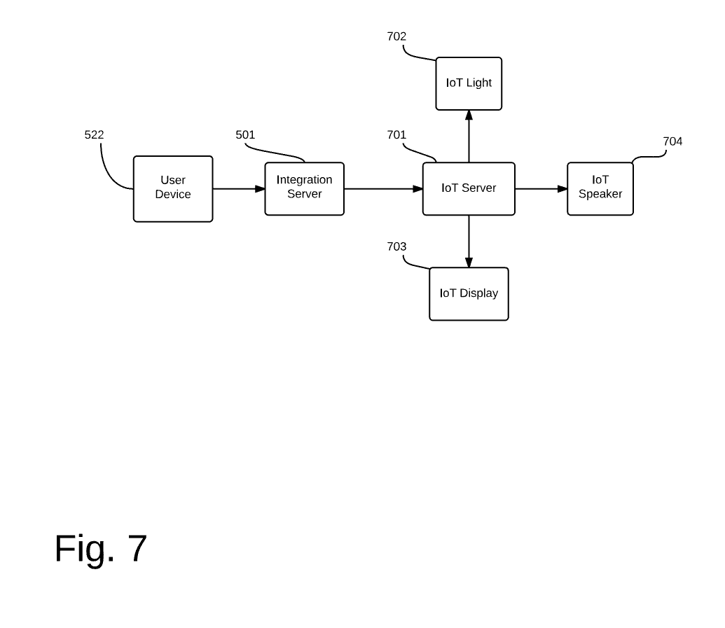

FIG. 7 is a block diagram of an exemplary architectural overview of a system arrangement utilizing a plurality of exemplary internet-of-things (IoT) devices. According to an IoT-based arrangement, a user's device 522 may communicate with an integration server 501 (generally via a network as described previously, referring to FIG. 5) to report that the user has interacted with a particular interactive element (as described previously, referring to FIG. 6). Integration server 501 may then direct an IoT server 701 (such as a software application communicating via a network, for example an IoT service such as IFTTT™ or a hardware IoT device or hub, such as WINK™, SMARTTHINGS™, or other such device) to perform an action or alter the operation of a connected device. For example, an interactive element may cause a connected light bulb 702 to change color or intensity, for example anytime a user clicks on the interactive element comprising, for example, a word “sunset” in their web browser. Another example may be an interactive element that causes a particular audio cue or song to be played on a connected speaker 704 such as a SONOS™ device or other “smart speaker”, for example to sound a doorbell chime whenever a user types the word “knock” in a messaging app on their smartphone (for example, this mode of operation may enable a simple doorbell function for users anytime someone sends them a message with the key phrase in it, without the need for a hardware doorbell configuration). In another example, an interactive element may trigger a particular image to be displayed or other behavior on a connected display 703, such as a “smart TV”, for example to simulate digital artwork by displaying a still image whenever a user interacts with a particular interactive element. Such a visual arrangement may be useful for users to conveniently change interior decor, exterior displays (such as publicly-displayed screens), or device backgrounds at will, as well as to enable remote operation of such functions by using various messaging or social networking services to operate as a “trigger” without requiring a user to have physical access to a device. For example, an art show curator may display a number of pieces in a gallery on display screens while the original works are safely stored in a different location, and may remotely configure what pieces are shown on particular displays without needing to travel to the gallery itself, enabling a single curator to manage multiple simultaneous galleries from a single location.

It should be appreciated that there may be many variations and combination of interactive elements, functional associations, and forms of interaction. Different combinations may be utilized to provide far more complex and unique operation than ordinarily possible in a simple “click here to do this” mode. For example, various IoT devices may be used to simulate interactive element interaction, such as (for example) using a motion sensor to simulate an interactive element interaction to automatically play a chime anytime a door is opened.

Actions may be associated to interactive elements (for example, selecting a known key word or phrase, or entering a selection of digits to instantiate an undefined collection of characters) that Users, via user devices, may click on via a user interface (for example, on a touch screen device, by using a computer pointing device, etc.). In a preferred embodiment, actions that may be triggered may include, but are not limited to: audio to be played, video to be played, vibrations to be experienced, emoticons to be experienced, or a combination of one or more of the above. In another embodiment, actions that may be triggered are ringtones, playback of midi, activate a wallpaper change (for example, on the background of a mobile device, a computer, etc.), initiate a window to appear or close, and the like. In some embodiments, a triggered action may occur or expire in a designated time frame. For example, a user, via a user device, may configure a trigger that produces a pop-up notification on their device only during business hours, for use as a business notification system. Another example may be a user configuring automated time-based events for home automation purposes, for example automatically dimming household lights at sunset, or automatically locking doors during work hours when they will be away. In this manner it can be appreciated that a wide variety of actions and trigger may be possible, and various combinations may be utilized for a number of purposes or use cases such as for device management, social networking and communication, or device automation.

According to an embodiment, “layers” may be used to operate nested or complex configurations for interactive elements or their associations, for example to apply multiple associations to an interactive element comprising of a single word or phrase, or to apply variable associations based on context or other information when an interactive element is triggered. As an example, a user, via a user device, may configure a conditional trigger using layers, that performs an action and waits for a result before performing a second action, or that performs different actions during different times of the day or according to the device they are being performed on, or other such context-based conditional modifiers. For example, a trigger may be configured to send an SMS text message on a user's smartphone, but with a conditional trigger to instead utilize SKYPE™ on a device running a WINDOWS™ operating system, or IMESSAGE™ on a device running an IOS™ operating system. Another example of layer-based triggers may be a nested multi-step trigger, that uploads a file to a social network, waits for the file to finish uploading, then copies and sends the new shared URL for the uploaded file to a number of recipients, and then sends a confirmation message upon completion to the trigger creator (so they know their setup is functioning correctly). This exemplary arrangement may then utilize an additional layer to add a conditional notification if an action fails, for example, to notify the trigger creator if a problem is encountered during execution.

A variety of configuration and operation options or modes may be provided via an interactive interface for a user, for example via a specially programmed device or via a web interface for configuring operation of their dictionary entries, associations, or other options. A variety of exemplary configurations and operations are described below, and it should be appreciated that a wide variety of additional or alternate arrangements or operations may be possible according to the embodiments disclosed herein and that presented options or arrangements thereof may vary according to a particular arrangement, device, or user preference.

FIG. 8 is an illustration of an exemplary embodiment of a resultant image triggered by a user interface comprising an interactive element to define a new layer of content for communication. According to the embodiment, image 800 is a resulting image from a directive received from a user device 522. Such a directive, for example, may be triggered by a number of core components, including receiving indication of pressure on a touch sensitive user device 522, a mouse-click on user device 522, or the like, when an interactive element (for example, a preconfigured word or phrase) is detected in a communication between one or more user devices 522. Upon identifying an interactive element, for example a previously configured word “cellfish”, system 500 may produce image 800 wherein resultant image 800 is previously configured comprising a combination of visual elements associated to the previously configured word “cellfish” wherein the word “cellfish” is stored in phrase database 541 and an associated image, or images, are stored in object database 540. In some embodiments, a library of images may be stored in object database 540 and such images may be combined in real-time based on previously configured association of images to words, for example, a word “cell phone” may have associated image portion 801 and a word “fish” may have associated image portion 802. In an embodiment where previously configured actions and images are associated to words, system 500 may combine image portion 801 and image portion 802 dynamically, if a combination (for example “cell phone fish”) or approximation of the combination (“cellfish”) was identified as an interactive element, for example, resulting in combined image 800.

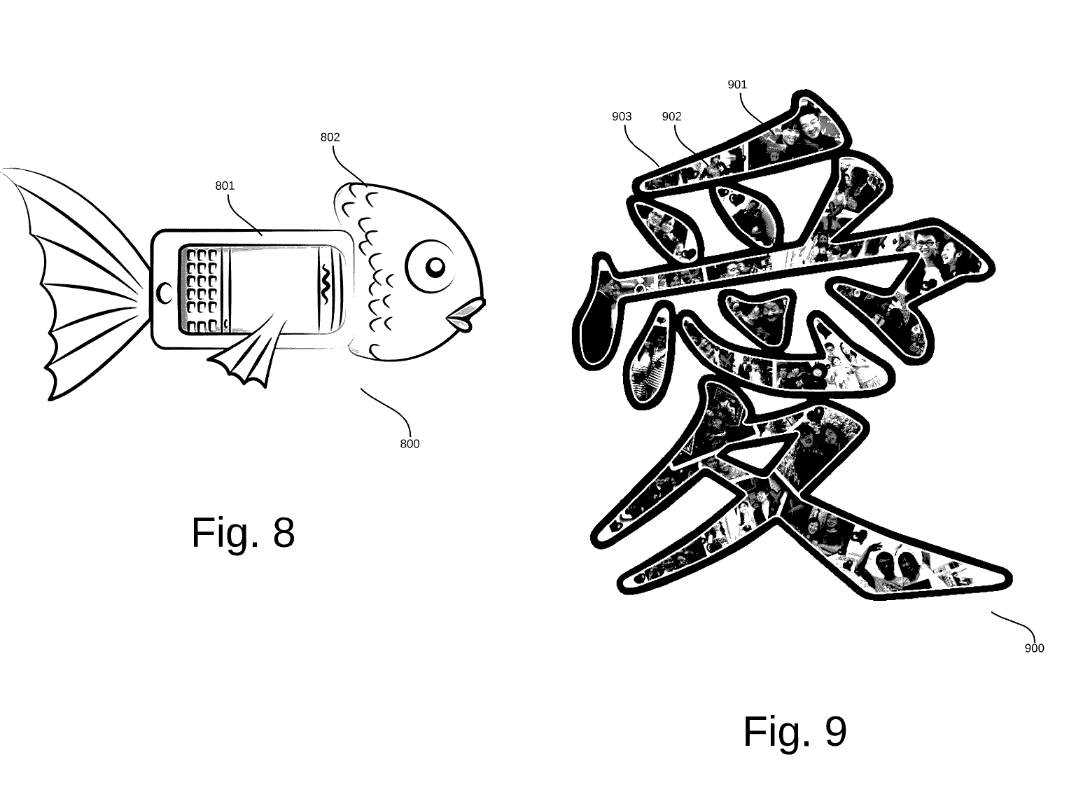

FIG. 9 is an illustration of an exemplary embodiment of a resultant image triggered by an interaction with user interface comprising an interactive element to define a new layer of content for communication. In this embodiment, a resultant image 900 representing, for example, a Chinese character meaning “love” which may result when an English word love is triggered (for example, by receiving an indication from user device 522 that an interaction element to define a new layer of content for communication associated to the word “love” was triggered). In this embodiment image 900 may be a Chinese character “love” comprising internal graphics images depicting “love and affection” and sent to user device 522. It should be appreciated that images 901 and 902 are images associated to the word (in this regard, “love”) that may be a result of a of a conversation on a target communication platform such as an instant messaging platform, social media platform, and the like. Image 901 within the character boundary 903 of image 900 may, for example, be an image of a happy couple. Image 902 within the character boundary 903 of image 900 may be an image of a couple in an embrace. In some embodiments the images 901 and 902 may have been preconfigured and associated by a user and stored in object database 540. In another embodiment, images may have been dynamically assembled in real-time and combined as needed. In some embodiments, an association to a phrase or word stored in phrase database 541 may be associated to an image or a video stored in object database 540 and triggered when the associated word or phrase is analyzed on the target communication platform, for example, TWITTER™, FACEBOOK™ timeline, SNAPCHAT™, or some other social communication platform. In some embodiment images or video borders are cropped by calculating border 903 of the character limits using systems known in the art to create variable borders around images or video. In yet another embodiment, character border 903 may define a container for FLASH™ content or some other interactive content, wherein the images or videos displayed within at least border 903 is presented using FLASH™ technology, or some other interactive content technology.

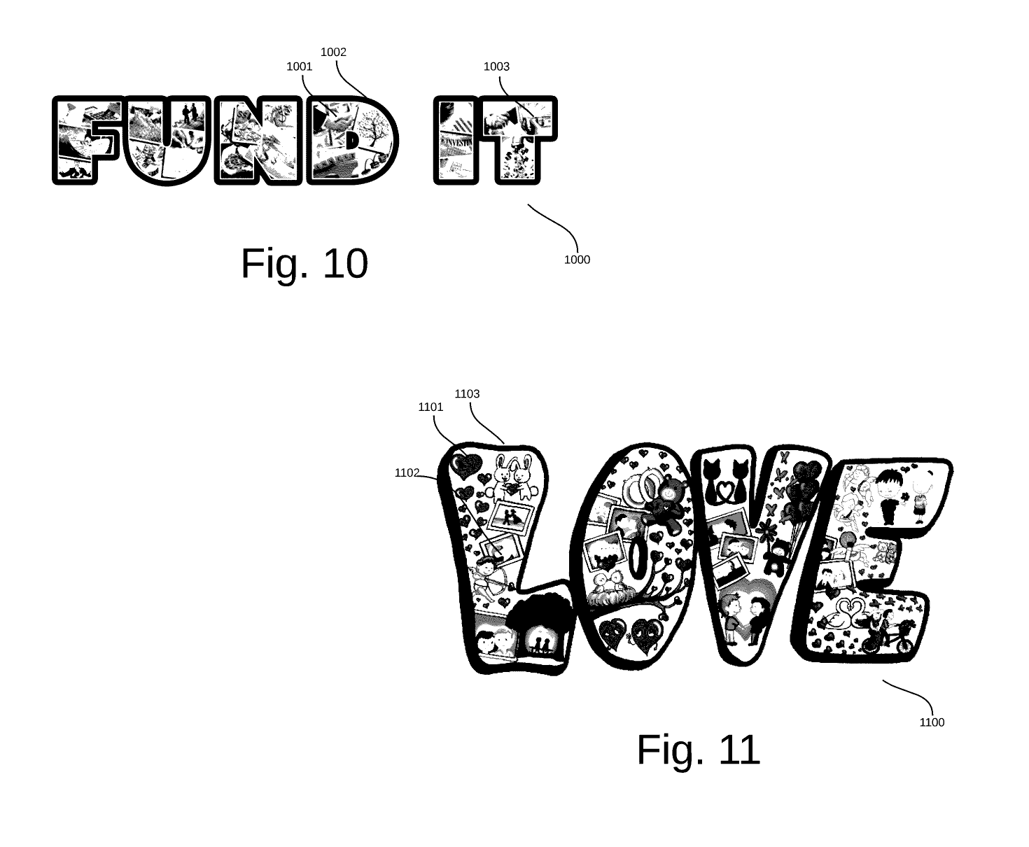

FIG. 10 is an illustration of an exemplary embodiment of a resultant image triggered by interaction with user interface comprising an interactive element to define a new layer of content for communication. In this embodiment, a resultant image 1000 comprises a graphical phrase “fund it” and may result when API 511 had received indication that, for example, a plain text word “fund it” having been displayed on user device 552 (for example, displayed by a plurality of users communicating through instant message, short messaging service, short message broadcast such as TWITTER™, FACEBOOK™ timeline, SNAPCHAT™, and the like, receives an interaction (for example, by receiving an indication from user device 522 that an interaction element to define a new layer of content for communication associated to the phrase “fund it” was triggered). In this regard, image 1000 may be delivered to user device 522 wherein the letters comprising an internal composition of images whereby the images may correspond to theme associated to the phrase of image 1000, for example images representing “funding something” may be embedded within at least letter boundary 1002 and may be displayed on user device 522 as a result, for example, of text analysis from a plurality of user devices 522. It should be appreciated that images 1001 and 1003 are, for example, images, graphics, clip art depicting appropriate imagery to which phrase 1000 is associated, for example, image 1001 may be an image of individuals shaking hands suggesting some sort of deal or agreement. Correspondingly, image 1003 may be an image of currency suggesting funding can be done via currency. In some embodiments images 1001 and 1003 may have been preconfigured and associated by a user. In another embodiment, image 1000 may have been previously sent to user device 522 and stored in its memory and retrieved when directed by system 500. In yet another embodiment, images may have been dynamically assembled in real-time and combined as needed. In some embodiments, image 1001 is cropped by calculating border 1002 defining character border limits for the character within the characters of image 1000. In yet another embodiment, character border 1002 may define a container for FLASH™ or some other interactive content, wherein image content 1001 and image content 1003 are displayed by embedding, for example, FLASH™ technology, or some other interactive content technology.

FIG. 11 is an illustration of an exemplary embodiment of a resultant image triggered by interaction with a user interface comprising an interactive element to define a new layer of content for communication. In this embodiment, a resultant image 1100 comprises a graphical phrase “love” and may result when API 511 had received indication that, for example, a plain text word “love” having been displayed on user device 552 (for example, displayed by a plurality of users communicating through instant message, short messaging service, short message broadcast such as TWITTER™, FACEBOOK™ timeline, SNAPCHAT™, and the like, receives an interaction (for example, by receiving an indication from user device 522 that an interaction element to define a new layer of content for communication associated to the phrase “love” was triggered). In this regard, image 1100 may be delivered to user device 522 wherein the letters comprising an internal composition of images whereby the images may correspond to theme associated the phrase of image 1100, for example images representing “love” may be embedded within at least letter boundary 1103 and may be displayed on user device 522 as a result, for example, of text analysis from a plurality of user devices 522. It should be appreciated that images 1101 and 1102 are, for example, images, graphics, clip art depicting appropriate imagery to which phrase 1100 is associated, for example, image 1001 may be an image of in a romantic setting suggesting some sort of affection for one another, or icons of hearts and flowers, and the like. Correspondingly, image 1102 may be an image of a marriage proposal implying a loving relationship. In some embodiments images 1101 and 1102 may have been preconfigured and associated by a user. In another embodiment, image 1100 may have been previously sent to user device 522 and stored in its memory and retrieved when directed by system 500. In yet another embodiment, images may have been dynamically assembled in real-time and combined as needed. In some embodiments, image 1101 is cropped by calculating border 1103 defining character border limits for the character within the characters of image 1000. In yet another embodiment, character border 1103 may define a container for FLASH™ or some other interactive content, wherein image content 1101 and image content 1102 are displayed by embedding, for example, FLASH™ technology, or some other interactive content technology.

FIG. 13 is an illustration of an exemplary interaction comprising an interactive element in an enriched multilayered multimedia communication, according to a preferred embodiment of the invention. Phrase 1301 in an exemplary interaction comprising a phrase 1301 “All you need is love” comprising a plurality of words, all 1302, you 1303, need 1304, is 1305, and love 1306 whereby love 1306 is configured as an interactive element. It should be appreciated that any indicia may be used to designate an interactive element such as, but not limited to, an embed code, a specific font, arrangement or element that may be easily identifiable by parser 1212. In this regard, parser 1212 receives the interaction and parses individual elements of phrase 1301, for example, all 1302, you 1303, need 1304, is 1305, and love 1306. Interactive element identifier identifies love 1306 as an interactive element and sends a request via query interactive element 1211 to retrieve any associated actions and/or attributes for interactive element love 1306. In this regard, an action may be, for example, to replace the word love with image 1312. Container creator 1214 then creates container 1311 to contain image 1312 and uses associated attributes for position and size. Display processor 1224 recreates phrase 1301 from the interaction into phrase 1310 where the phrase is maintained except the interactive element is replaced by the container and the image is displayed within the bounds of the container. Resultant image 1610 is then displayed to display 1222.

It should be appreciated that attributes may determine a size, behavior, proportion and other characteristics of container 1311. For example, the size of container 1311 may be computed to provide a pleasing view of interaction 1310. In some embodiments container 1311 may dynamically change attributes (for example, size) while being displayed on display. In another embodiment, the container may encompass the background of display 1222 whereby the interaction is displayed as-is, but with a new background. In should be appreciated that the boundary of container 1311 may not be visible in some embodiments.

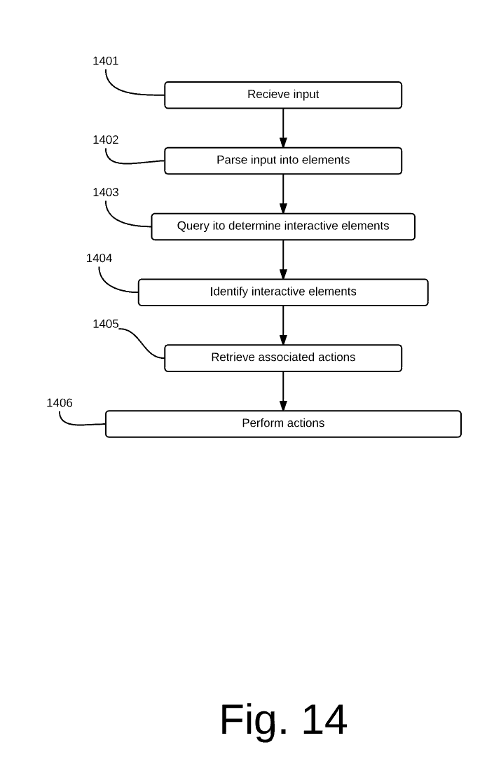

FIG. 14 is an illustration of an exemplary processing of interactive elements in an enriched multilayered multimedia communications environment, according to a preferred embodiment of the invention. In step 1401, a plurality of interactions may be received from get interaction 1210. Interactions may be text, audio or video and may come from network 530 or from device 522 via device input 1217. In one embodiment where an interaction received from device input 1217 is audio or video, ASR 1225 performs automatic speech recognition on the audio portion of the interaction and passed to parser 1212 by get interaction 1210. In another embodiment where the input is already text, the interaction is passed to parser 1212 by get interaction 1210 without requiring ASR 1225. In a next step 1402, the interaction is parsed into elements by parser 1212 which may comprise a plurality of programming instructions configured to receive the interaction as input, for example, in the form of sequential alpha numeric characters, interactive online commands, markup tags, or some other defined interface. Parser 1212 then breaks the interaction up into parts (for example, a plurality of words or phrases, a plurality of interactive elements, and any attributes and/or options that may be included as metadata) that may be then be managed by interactive element identifier 1213. interactive element identifier 1213 identifies any interactive elements in step 1403 by querying interactive elements database 1221 with each parsed element. Once all interactive elements are defined in step 1404, any associated actions are retrieved from action database 1220 in step 1405. For example, an action may include displaying an image in pace of the interactive element, changing the background of display 1222 of device 522, or other behaviors outlined previously and in section “interactive elements”. Attributes from actions are used by container creator 1214 to manage how the action will be displayed. Once the characteristics of the actions are determined, actions are performed in step 1406 by either display processor 1224 and outputted to display 1222, or in some embodiments, an audio file will be played via device output 1217.

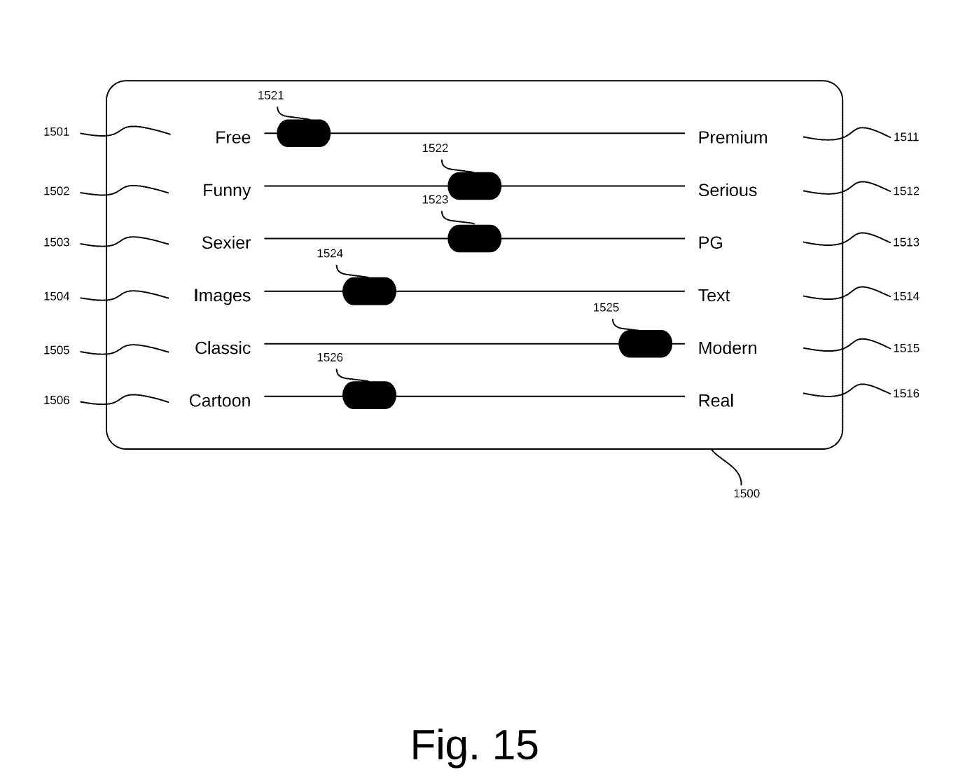

FIG. 15 is an illustration of an exemplary configuration of interactive elements in an enriched multilayered multimedia communications environment, according to a preferred embodiment of the invention. According to the embodiment, an interactive element configuration tool 1500 may be used to determine guidelines for how associated actions, images, videos, and other elements will appear on display 1222 of user device 522 (as described in FIG. 12), for example based on user preference, based on age appropriateness based on age-specific classifications, or the like. In this regard, metadata may contain different versions of objects (for example images, videos, language) within object database 540. According to the embodiment an interactive element configuration tool 1500 comprises a plurality of horizontal sliders 1521-1526 visible, for example, on display 1222 of user device 522 that a user of user device 522 may use to drag sliders 1521-1526 to change a value between a minimum and a maximum value. For example, slider 1521 may establish guidelines for deciding a level between actions (that is displaying images, videos, text, etc. as described previously) between free content 1501 and premium content 1511. It can be appreciated that the position of slider 1521 and its proximity to one side or the other determines the degree of relevance to the one close. For example, slider 1521, being within closer proximity to free 1501, would indicate that the user prefers free versus premium content. Similarly, slider 1522 determines, for example, an equal amount of funny 1502 content versus serious 1512 content. Similarly, slider 1523 determines, for example, an equal amount of sexier 1503 content versus PG 1513 content. Similarly, slider 1524 determines, for example, a greater amount of image-based 1504 content versus text-based 1514 content. Similarly, slider 1525 determines, for example, a greater amount of modern 1505 content versus classic 1515 content. Similarly, slider 1526 determines, for example, more cartoon-like imaging 1506 versus real-type imaging 1516 content. It should be appreciated that any configurable element can be placed in a slider-type 1500 arrangement. For example, “street′ er” versus less “street′ er”, action versus less action, cranks versus community, still frame versus video, used before versus new, mainstream versus fringe, affirming versus demeaning.

FIG. 16A is an illustration of an exemplary configuration of a software interface for selecting and assigning interactive elements using a text search query, according to a preferred embodiment of the invention. According to the embodiment, a user device 522 may be used to participate in a text conversation 1610. Within a conversation, an interactive element search bar 1611 may be used to search or browse interactive elements using keywords or phrases, and interactive elements matching a search query may be displayed 1612 for selection. For example, a search query for “dog” might present a variety of text, icons, images, or other elements pertaining to “dog” (for example, a “dog tag” icon or an image of a bag of dog food), which may then be selected for insertion. Additionally, interactive elements may be suggested as a user inputs text normally, for example in a manner similar to an “autocomplete” feature present in some software-based text input methods, so that a user may converse normally but still retain the option to select relevant interactive elements “on the fly”, without disrupting the flow of a conversation.

FIG. 16B is a further illustration of an exemplary configuration of a software interface for selecting and assigning interactive elements using audio input, according to a preferred embodiment of the invention. According to the embodiment, a user device 522 may be used to participate in a text conversation 1610. Within a conversation, a dictation prompt 1621 may be used to record speech for use, for example to search for interactive elements via spoken keywords or phrases, or to record an audio segment and associate interactive elements with the audio or portions thereof. For example, a user may record a spoken message and interactive elements may be automatically or manually associated with specific portions of the message, such as coinciding with particular words or phrases recognized. When the audio message is then shared (for example, in a chat conversation or via posting to an online social media network), these interactive elements may then be presented for interaction along with the audio recording, and other users may be given the option to modify or add new interactive elements according to a particular arrangement. Interactive elements may be optionally presented as a group, for example “all interactive elements in this recording”, or they may be presented only when an audio recording is at the appropriate position during playback, such that an interactive element for a word or phrase is only presented when that word or phrase is being played in the audio segment.

FIG. 16C is a further illustration of an exemplary configuration of a software interface for selecting and assigning interactive elements using a radial menu interface, according to a preferred embodiment of the invention. According to the embodiment, a radial menu interface 1630 may be presented when text is selected on a user device 522. Radial menu interface 1630 may display a variety of interactive element types or categories to provide an organized hierarchical structure for navigating and selecting interactive elements to associate with the selected text. Exemplary categories may include images 1631, audio 1632, map landmarks or location data 1634, or other types of content that may be used to classify or group interactive elements (and some interactive elements may be present in multiple categories as needed). In this manner, a user may be provided with an interactive menu to rapidly select relevant content for use in interactive elements with the text they've selected, and may use a radial menu interface 1630 to associate interactive elements with existing text (for example, from another user's social media posting or chat message) rather than inserting interactive elements while inputting their text (as above, in FIG. 16A).

### Interactive Elements

Interactive elements may comprise a plurality of user-interactive indicia, generally corresponding to a word, phrase, acronym, or other arrangement of text or glyphs according to the embodiments disclosed herein. According to the embodiment, A user, via a user device, may enable the registration of interactive elements or phrases (for example words with a known definition, acronyms, or a newly created word comprising a collection of alphanumeric characters or symbols that may be previously undefined) that become multidimensional entities by “tapping” a word in a user interface or by entering it into a designated field (or other user interaction, for example a physical “tap” may not be applicable on a device without touchscreen hardware but interaction may occur via a computer mouse or other means). In some embodiments, the word, phrase, acronym, or other arrangement of text may come as a result of an automatic speech recognition (ASR) process conducted on an audio clip or stream. In some embodiments, interactive elements may become multidimensional entities by entering the interactive element into a designated field via an input device on a user interface. Users, via user devices, may import and/or create visual or audio elements, for example, emoticons, images, video, audio, sketches, animation just by tapping on the user interface designating the element to define a new layer of content to a communication. Having initiated the process of creating an interactive element, a user is instantiating and registering a new entity of any of the above mentioned elements, to create a separate layer that can be accessed just by tapping (to open up a window), and it becomes possible create new experiences within these entities.

According to an embodiment, elements may be added to a pop-up supplemental layer (that is, a layer that becomes visible as a pop-up message within a configuration interface or software application), for example: a definition for a word the user has created (this may be divided into multiple types of meanings and definitions), or possible divisions between text definitions, audio definition, or visual definition. Definition types might for example include “mainstream” (publicly or generally-accepted definitions, such as for common words like “house” or “sunset”), “street” definitions (locally-accepted definitions, such as custom words or lingo, for example used within a certain venue or region), or personal definitions (for custom user-specific use). A user, via a user device, may add these, for example, with a “+” button or similar interactive means via a user device, for example via a pulldown menu displaying various definition options.

A user, via a user device, may create an interactive element within an interactive element, for example to utilize existing interactive elements anywhere in an interactive element that they may add text or media (creating nested operations as described previously). Synonyms for an interactive element (for example, “linguistic synonyms” with similar or related words or phrases, or “functional synonyms” with similar actions or effects) may also be enabled as interactive elements which can be explored (for example, a new interactive element opens with an arrow to go back to the previous one). Separate from synonyms, there may also be a section for similar or related interactive elements, and it may be possible to let other users add their own interactive elements, optionally with or without approval (for example, for a user to maintain administrative control over their interactive elements but to allow the option of other user submissions or suggestions that they may explicitly approve). Links to references or info for a particular interactive element or definition may include online information articles (such as WIKIPEDIA™, magazines or publications, or other such information sources), online hosted media such as video content on YOUTUBE™ or VINE™, or other such content.

A variety of exemplary data types or actions that may be triggered by an interactive element may include pictures, video, cartoon/animation, stick drawings, line sketches, emoticons of any sort, vibrations, audio, text, or any other such data that may be collected from or presented to, or action that may be performed by or upon a device. These data types may be used as either part of a definition, or something that gets immediately played before going into a main supplemental layer of definitions, for example a video to further express the definition or the meaning. Some specific examples include song clips, lyrics, other emoticons that A user, via a user device, may have been sent, or ones they may upload; physical representation of sentiment such as heartbeat or thumbprint, or kiss-print, blood pressure reading, data collected by hardware devices or sensors, or any other form of physical data; symbolic representation of sentiment such as a thumbs ups, like button, an emoticon bank, or the like. In one embodiment, a user can engage an interactive element and see, for example an image of the recipient, a rating system, or other such non-physical representations of user sentiment.

A user, via a user device, may optionally have a time limit in which an interactive element is usable, or a deadline at which time the interactive element will “self-destruct” (i.e. expire), or become disabled or removed. For example, an interactive element may be configured to automatically expire (and become unusable or unavailable for viewing or interaction) after a set time limit, optionally with a “start condition” for the timer such as “enable interactive element for one hour after first use”. Another example may be interactive elements that log interactions and have a limited number of uses, for example an action embedded in a message posted to a social network such as TWITTER™, that may only be usable for a set number of reposts or “retweets”. An additional functionality that may be provided by the use of layers, is additional actions that may be performed when an interactive element reaches certain time- or use-based timer events. For example, a post on TWITTER™ may be active for a set number of “retweets”, and after reaching the limit it may perform an automated function (as may be useful, for example, in various forms of games or contests based around social network operations like “following” or “liking” posts).

A password-protected interface may be used where a user can add or modify actions, dictionary words, interactive elements, layers, or other configurations. For example, a virtual lock-and-key system where an interactive element creator has power over who can see a particular section or perform certain functions, providing additional administrative functionality as described previously. A user, via a user device, may also create a password-protected area within a third-party entity (such as another user's dictionary where they have appropriate authorization), which someone else can see only if they have access (enabling various degrees of control or interaction within a single entity according to the user's access privileges).

A user, via a user device, may optionally enable access rules or a “public access” mode whereby others can make changes to an entity that they (the user) have authored or created, for example by adding, editing, or even subtracting elements. The user can thereby approve or alter changes, and may credit the author of a change in an authorship or history section, for example presented as a change that is visible in a timeline of event changes. For example, A user, via a user device, may optionally have a history or authorship trail which tracks different variations of the evolution of an entity (like a tree), which is either viewable only by either the author, or the author and the recipients/viewers, as per the choice of the author.

A user, via a user device, may enable or facilitate communication within an interactive element, for example by using a chatroom about the content or message associated with the interactive element theme which resides inside the interactive element entity, or a received message that opens up an interactive element, word, or image in the user's application, so that it is presented and the user experiences or receives the message inside of that entity. A user, via a user device, may also include or “invite” others in a conversation, regardless of whether they have used a particular entity before.

From within an interactive element, a user can allow users to re-publish a word, such as via social media postings (for example, on TWITTER™ or FACEBOOK™), or manually after creating the interactive element (such as from within it). The options may be presented differently for the author or a visitor, for example to present preconfigured posting that may easily be uploaded to a social network, or to present posting options tailored to the particular user currently viewing the interactive element.

A user, via a user device, may decide whether other users or visitors can see an interactive element and the words in it, for example via a subscription or membership-based arrangement wherein Users, via user devices, may sign up to receive new interactive elements (or notifications thereof) with those words in them (for example they may sign up, and determine settings, or other such operations). For example, A user, via a user device, may “toggle” interactive elements on or off, governing whether they are visible at all to others—and, if visible, how or whether an interactive element may be used, republished, modified, or interacted with.

A user, via a user device, may add e-commerce capacity, for example in any of the following manners: A user, via a user device, may let people buy something (enable purchases, or add a shopping cart feature); A user, via a user device, may let people donate to something (add a “donation” button); A user, via a user device, may let people buy rights to use their interactive element entity (“purchase copy privileges”); or A user, via a user device, may let people buy the rights to use and then redistribute an entity (“purchase copy and transfer privileges”).

A user, via a user device, may add a map feature within an interactive element which lets them (or another user, for example selected users or groups, or globally available to all users, or other such access control configurations) see where an entity has been published, or let others see where it is being used. For example, a user, via a user device, may publish an interactive element via a social network posting and then observe how it is propagated through the network by other users.

A user, via a user device, may see who uses their words, or who uses similar language, or has similar taste in what interactive elements they use or have “liked”, or other demographic information. A user, via a user device, may rate an interactive element, nominate it for public consumption, or sign up for new language updates by an author. A user, via a user device, may see who uses a similar messaging style, for example similar messaging apps or services, or similar manner of writing messages (such as emoticon usage, for example). Additionally, A user, via a user device, may create a “sign up” feature to get updates whenever something inside an interactive element changes, or if there is a content update by the creator or owner of the interactive element.

A user, via a user device, may create a function that has the words of an interactive element linked to a larger frame of lyrics, which content providers can use to create a link to a song or a portion of a song. Optionally, an application may auto-suggest songs from a playlist when there is a string match of lyrics (for example, using lyrics stored on a user's device or on a server, such as a public or private lyric database). For example, this may be used to create an interactive element that is triggered whenever a song (or other audio media) is played on a device or heard through a microphone, based on the lyrics or spoken language recognized.

A user, via a user device, may create and link existing interactive elements to those of other users as possible replies for someone to send back, or to let others do this within an interactive element. This may be used as a different element of response than an auto-suggest, occurring within an interactive element itself rather than within an interactive element management or admin interface.

A user, via a user device, may “tag” an interactive element or content within an interactive element with metadata to indicate its appropriateness for certain audiences/demos. For example, a user, via a user device, may define an age range or an explicit content warning. A user, via a user device, may decide whether an interactive element they have created is a public, private, co-op, or other forms of access control. If public, it may still have to reach a threshold or capacity to enter auto-suggest system. If co-op, the user may choose rules for it such as by using standardized options, or creating custom criteria based on people's profile data (such as using geography or demographic information). If private, A user, via a user device, may define a variety of configurations or rules. For example, “just contacts that the user explicitly approves”, or “anyone with this level of access”, or other access control configurations. A user, via a user device, may choose to send to someone, but restrict access such that the recipient can't send or forward to someone else without requesting permission (for example, to share media with a single user without the risk of it being copied or distributed). Optionally, private interactive elements may be blocked from screen capture, such as by configuring such that pressing the relevant hardware or software keys or inputs takes it out of the screen before it can be saved. Another variation may be a self-destruct feature that is enabled under certain conditions, for example, to remove content or disable an interactive element if a user attempts to copy or capture it via a screen capture function.

A user, via a user device, may designate costs associated with an interactive element. For example, to use it in messages that are sent, or in any other form such as chat, or on the Internet as communication icons embedded in an interface or software application, or other such uses. This may be used by a user to sell original content themselves or to make them high frequency communicators, and to give incentive for users (such as celebrities or high-profile users within a market) to disperse language.

A user, via a user device, may initiate a mechanism to prevent people from “spamming” an interactive element without permission, for example using delays or filters to prevent repeated or inappropriate use. A user, via a user device, may enable official interactive element invites for others to experience an interactive element (optionally with additional fields for multiple recipients). A user, via a user device, may link to other synonymous interactive elements to get more exposure for an interactive element. A user, via a user device, may have an interactive element contain “secret language”, or language known only to them or a select few “chosen users”, for example. This may be used in conjunction with or as an alternative to access controls, as a form of “security through obscurity” such as when a message does not need to be hidden but a particular meaning behind it does.

An interactive element may be designated to be part of an access library for various third-party products or services, enabling a form of embedded or integrated functionality within a particular market or context. For example, a user, via a user device, may configure an interactive element for use with a service provider such as IFTTT™, for a particular use according to their services. For example, an interactive element may be configured for use as an “ingredient” in an IFTTT™ “recipe”, according to the nature of the service.

A user, via a user device, may configure a “smartwatch version” or other use-specific or device-specific configuration, for example in use cases where content may be required to have specific formatting. For example, interactive elements may be configured for use on embedded devices communicating with an IoT hub or service, such as to enable device-specific actions or triggers, or to display content to a user via a particular device according to its capabilities or configuration. An example may be formatting content for display via a connected digital clock, formatting text-based content (such as a message from a contact) for presentation using the specific display capabilities of the clock interface.

A user, via a user device, may create their own language which may be assigned in an interface with glyphs corresponding to letters or symbols, and a password or key required to unscramble, as a form of manual character-based text encryption. A user, via a user device, may optionally choose from an available library (such as provided by a third-party service, for example in a cloud-hosted or SaaS dictionary server arrangement), or create or upload their own. For example, a cipher may be created to obfuscate text (such as for sending hidden messages), or arbitrary glyphs may be used to embed text in novel ways such as disguising text as punctuation or diacritical marks (or any other such symbol) hidden within other text, transparent or partially-transparent glyphs, or text disguised as other visual elements such as portions of an image or user interface.

To help manage the context of access to messaging content, there may be a designation of contacts or contact types. Examples could be: Parent, Sibling, Other Family, Friend, Frenemy, Teammate, BFF, BFN, Girlfriend, Boyfriend, Flirt, Hook-up, or other such roles. Additional roles may possibly include the following: professional designations such as Lawyer, Accountant, Firefighter, Dentist, My doctor, A doctor, or others; a cultural designation such as Partier, Player, Musician, Athlete, Poet, Activist, Lover, Fighter, Rapper, Bailer, Psycho or others; a special designation such as Spammer, “Leet” Message, “Someone who I will track their use of language”, “I want to know when they create a new interactive element”, or other such designations that may carry special meaning or properties. A user, via a user device, may optionally add various demographic data, such as Age, Nationality, City, Province, Religion, Nickname, Music Genre, Favorite Team, Favorite Sport Superstars, Favorite Celebrities, Favorite Movies, Television Shows, Favored Brand, Favored

If a user types in any word into a designated “create” field, they may be able to see the exact or synonymous interactive elements that their contacts have posted, or that a community has posted, or see what others use by clicking on an indicium (such as an image-based “avatar” or icon) for a user or group. A user, via a user device, may also see related synonyms that people use, for example including celebrities or other high-profile users. A user, via a user device, may then decide to continue creating their own interactive element, or they may choose to instead use one of the offered suggestions (optionally modifying it for their own use).

Entities may be tracked by various metrics, including usage or geographic dispersion. Once an entity surpasses a threshold of distribution, it may be qualified for “acceleration”, becoming public and incurring auto-suggesting, trending, re-posting or re-publishing, or other means to create awareness to the entity. In this manner entities may be self-promoting according to configurable rules or parameters, to enable “hands-free” operation or promotion according to a user's preference.

Actions may also be associated with new modalities of communication which are not seen, for example instances of background activity where a software application may carry out an unseen process or activity, optionally with visible effects (such as text or icons appearing on the screen without direct user interaction, triggered by automated background operation within an application). This can be associated with an interactive element, but also accessed within a dropdown menu in an app. A user, via a user device, maybe able use such functionality to interact with other people they aren't in direct conversation with, for example to affect a group of users or devices while carrying on direct interaction with a subset or a specific individual (or someone completely unrelated to the group).

A user, via a user device, may modify a recipient's wallpaper (i.e. background image) on their user device to send messages, or trigger the playing of audio files either simultaneously with the image or in series, for example, crickets for silence, a simulated drive-by shooting to leave holes in the wallpaper, or other such visual or nonverbal messages or effects. This particular function can be associated with an interactive element that is sent to a user (that changes their wallpaper temporarily, or permanently), or a user can command the change through an “auto-command” section. The user may then revert their wallpaper, or reply with an auto-suggested response or a custom message of their own.

Messages may optionally be displayed in front of, behind, or within portions of the user interface: behind the keyboard, at the edges, or other visual delineation. Images may be displayed to give the impression of “things looking out”: bugs, snakes, ghosts, goblins, plants growing, weeds growing between the keys when they aren't typing, or other such likenesses may be used. Rotating pictures may be placed on a software keyboard, or other animated keys or buttons. Automatic commands or triggers may comprise sounds or vibrations, including visually shaking a device's screen or by physically shaking a device, or other such physical or virtual interaction.

User may send messages from a keypad, such as designated sounds to each key. For example, associations may be formed such as “g is for goofball, funny you'd choose this letter” which may trigger a specific action when pressed, or type a sentence and have each word read aloud when they try and type out the message, or have custom sounds when they hit a key, like audio clips of car crashes if they are typing while mobile, or spell out a sentence like “stop typing, go to bed” that gets played with every n key presses (or every key press of a particular key, or other such conditional configuration). Another example may be that a user, via a user device, may assign groans and moans to certain words that are typed. For example, if someone is an ex-girlfriend, a user could assign the word “yuck” to her name, and trigger an associated audio or other effect. A user could have a list of things that trigger sounds for anyone, including users they may not explicitly know (for example, a user of whose name they are aware, but not on a “friend list” or otherwise in direct contact), and may optionally configure such operation according to specific users, groups, communities, or any other organization or classification of users (for example, “anyone with an ANDROID™ device”, or “anyone in Springfield”). A user, via a user device, may assign special effects to each word that comes up, like words that visually catch on fire and burn away, or words that have bugs crawl out of them when they are used. For example, a child may send a message with the word “homework” to their parent, which could trigger an effect on the parent's device. Additionally, text may have interactive elements assigned in this fashion regardless of the text's origin, for example in a text conversation on a user device 522, a user may assign interactive elements to text in a reply from someone else. Interactive elements may be “passed” between users in this manner, as each successive user may have the ability to modify interactive elements assigned to text, or assign new ones.

An interactive element create interface may allow a user to choose templates in the form of existing icons and items, that allow you to create similar formats of things, or they can just build from scratch. These may not be the actual icons, but are examples of the sorts of classifications of things that may be built with the tool: create a own name/contact tab (an acronym, or just something with cool info that others can open); contact interactive elements (create an interactive element for a person who is in a contact list); people interactive elements (create an interactive element for a person who isn't in a contact list); fictional character (an acronym or backronym, or an image or cartoon image that expands into something, like one for “Tammi” that expands to “This all makes me ill”); existing groups (Existing Bands, Groups, Political Parties, Teams, Schools); non-existing group (for example, “you want to start a group associated with a word! Start a club or a movement that is a co-op group, or your group”); business or brand interactive element (optionally must pay to have e-commerce function); event interactive elements including upcoming event (with a timestamp of when it begins and ends), current event (create an event for something that is going on right now, and an alert gets sent out about it), a past event (create an interactive element for a memory, or a past event, for example “The time we went to Paris . . . ”); places like a city, country, house, secret hide out (anything with a GPS location); art and media (movies, songs, videos, and clips); story (send an interactive element for breaking news, gossip, or whatever else needs to get around); ideas (invent a word with an idea, or associate a word with an idea); “say something really funny” (optionally with another layer of punchline); acronyms (give users a layer to explore); polls (create a vote or a poll on something); or send a charity message and raise money for a cause; a classification of message such as a hello or goodbye, or a compliment, insult, or a joke; picture interactive element (create another layer to an interactive element-able picture or emoticon); picture gallery interactive element (create a picture gallery for a word); emoticon interactive elements; video message interactive element; sound interactive elements; vibration interactive elements; heartbeat interactive elements; wallpaper interactive element; or keyboard interactive element.

Exemplary types or categories of interactive elements may include (but are not limited to):
Acronyms: general
Names
Ideas, Words
Art/Media
Person/Groups
Places
Things
Events
Business/Brands
Actions
Picture/emoticon/video
My Contact
Acronym (person, place, expression)
Person (for example, in a contacts organizer, not present in a contacts organizer)
Celebrity or fictional character
Place (for example, city, country, house, bar, anything with a GPS location)
Events (for example, current, past, future, anything with a timestamp)
Businesses/Brands
Charities

In some embodiments, interactive elements may be presented to A user, via a user device, maybe represented as a series of icons that they can click on to see their styles, for example an acronym, a friend, a celebrity, a city, a party, business, brand, charity word, or other such types as described above.

Additional interactive element behaviors may include modifying properties of text or other content, or properties of an application window or other application elements, as a reactive virtual environment that responds to interactive elements. For example, a particular interactive element may cause a portion of text to change font based on interactive elements (such as making certain text red or boldface, as might be used to indicate emotional content based on interactive element or phrase recognition), or may trigger time-based effects such as causing all text to be presented in italics for 30 seconds or for the remainder of a line (or paragraph, or within an individual message, or other such predetermined expiration). Another example may be an interactive element that causes a chat interface window to shake or flash, to draw a user's attention if they may not be focusing on the chat at the moment. Content may also be displayed as an element of a virtual environment, such as displaying an image from an interactive element in the background of a chat interface to simulate a wallpaper or hanging painting effect, rather than displaying in the foreground as a pop-up or other presentation technique. These environment effects may also be made interactive as part of an interactive element, for example, if a user clicks or taps on a displayed background image, it may be brought to the foreground for closer examination, or link to a web article describing the image content, or other such interactive element functions (as described previously). In this manner, interactive element functionality may be extended from the content of a chat to the chat interface or environment itself, facilitating an interactive communication environment with much greater flexibility than traditional chat implementations.

Another exemplary use for interactive elements may be to communicate across language or social barriers using associated content, such as pictures or video clips that may indicate what is being said when the words (whether written or spoken) may be misunderstood. Users, via user devices, may create interactive elements by attaching visual explanations of the meaning of words or phrases, or may use interactive elements to create instructional content to associate meaning with words or phrases (or gestures, for example using animations of sign language movements).

In addition to specific content (such as images, audio or video clips, text or environment properties, or other discrete actions or content), interactive elements may incorporate “effects” to further enhance meaning and interaction. For example, an interactive element that associates an image with a word (for example, a picture of a person laughing with the phrase “LOL”) may be configured to display the image with a visual effect, such as a “fade in” or “slide in” effect. For example, an image may “slide out” of an associated word or phrase, rather than simply being displayed immediately (which may be jarring to a viewer). Additional effects might include video or audio manipulation such as noise, filters, or distortion, or text effects such as making portions of text appear as though they are on fire, moving text, animated font characteristics like shifting colors or pulsating font size, or other such dynamic effects. Such dynamic effects may optionally be combined with static effects described above, such as changing font color and also displaying flames around the words, or other such combinations.

### User Input

Aside from creating interactive elements and content, as a recipient a user, via a user device may do a number of things, some examples of which are described below.

A user, via a user device, may create their own secret language which uses an interface to assign media to letters or numbers, and creates a key/scramble feature which lets users unlock it. For an extra layer of protection, the appearance of the characters may be changeable based on time-based criteria such as what day or hour it is, making it harder for anyone to figure out a user's language. A user, via a user device, may optionally let a co-op user define their own language as well, for example so that Users, via user devices, may collaboratively create a secret language for use between them.

A user, via a user device, may access a website or application connected to a database library populated by the creation of interactive elements, that may let them communicate in an abstract manner. A user, via a user device, may use an interactive element creation process to create new ways to communicate, and other users, via user devices, may use what is already in the library. New creations or submissions may optionally be propagated to other libraries, and can be made available for interpersonal communications.

A user, via a user device, may create lists in various formats that may be sent to others, optionally as a questionnaire or poll where user feedback may be tracked and new lists created or submitted, for example so that users, via user devices, may compare lists of “top ten favorite movies” or similar uses.

A user, via a user device, may create a group or “tribe” that can access a certain interactive element or content. A user, via a user device, may create a virtual place connected to an interactive element. A user, via a user device, may perform various editing tasks in the process of sending a regular media file, or optionally use the tools to create messages within formatting provided for a particular use, such as compatibility with a particular website or application.

Users, via user devices, may also perform various activities or utilize functions designed to promote or enhance a particular application, webpage, or content. For example:
rate items, edit items, create synonymous items, linked items
nominate an item for trending
add items to their favorites
re-publish cool things with a link to a page
sign up to receive new interactive elements, as originally configured, or with other criteria, such as: location, within or outside known contacts

Examples of a creation interface's appearance may include:
word/phrase/text string
author's distance or location with reference to another user
a user's distance or location with reference to another user
age of author
an interactive element by a certain author
an interactive element that may have hit critical mass or usage of a particular value
an interactive element that may have a critical rating of a particular value
an interactive element that may have video, audio, other types of media
a user, via a user device, may sign up to receive new interactive elements from a certain person, similar to “following” on a social network
an interactive element that may have been linked to a particular person
an interactive element that may be based to a particular topic
an interactive element that may have a particular rating
an interactive element that may have reached a threshold in critical mass

Such operations may be facilitated by a number of core components, including a database with a library of interactive elements and associated media that can be accessed to contribute to a message. As users, via user devices, create messages, they may be tagged with synonymous words so that they can be used as suggestions. Using this feature, a user, via a user device, may convert a message to a string of characters for example, for abstraction. Each element of a message, and ‘message content’ may be classified as multiple things. Designations such as “hello”, or “goodbye”, or a joke, or an event, a person, or others may be assigned manually. Responses may optionally be rated according to their use, frequency, publication, or other tracked metrics, and this tracking may be used to tailor suggestions or assign a “most popular” response, for example. Responses may also be assigned various metadata or tags, associations and ratings, for example as part of an automated engine that defines the candidacy, ranking, and suitability of an element to be suggested in various scenarios. Each message or element may be associated as a logical response to other things, intelligently forming and selecting associations and assignments with regard to meaning or context. The amount that people use a particular message in a particular context/association with interactive elements may be tracked, and used to recommend to people, based on their classification as the person is either a parent, friend, close friend, boyfriend, girlfriend, work colleague, or others. Supplemental content sources may include a trending feature that shows the most recent popular interactive elements, triggers, and community created content, and has a feature where you can only communicate by interactive elements and abstract communications to comment on stories. In a personal profile section, a user, via a user device, maybe encouraged to make a “top 10” to help define the sort of content they prefer, and to aid others in sending content.

Various arrangements according to the embodiments disclosed herein may be designed to create more addictive, targeted, entertaining conversations, but also has the potential to create more positive conversations, where more entertaining conversations are enabled where the amount of offensive communication may be mitigated based on the profile or preferences and habits of a recipient.

According to an embodiment, a system may track the use of abstract expression components, which may be used to auto-suggest items for a user at various points/contexts of conversation. This may be used to help an application understand positioning within a conversation, for the purpose of suggestion. For each interactive element, data may be mined to help determine its suited context of use and this information may optionally be combined with an additional layer of user or conversation information, for example:
how often it has been sent per user (forms a ranking number against others overall, and against other synonymous ones, and against ones in its tagged category—e.g. hello's)
type of contact: BFF vs. Parent vs. Frenemy vs. Boyfriend, Girlfriend, Work Colleague, etc.
as an expression/quantification of a median usage with these different types of contacts since it reached capacity to become public
a ranking for the abstract message
conversation analytics such as type or cadence of speech, emoticon usage, or other information relating to “how” something is being used
device information such as device type (smartphone, smartwatch, laptop computer), or hardware capabilities (touchscreen, WiFi, cellular frequency bands)
demographic information such as age or gender, etc.

The skilled person will be aware of a range of possible modifications of the various embodiments described above. Accordingly, the present invention is defined by the claims and their equivalents.

What is claimed is:

1. A system for enriched multilayered multimedia communications, comprising:
A network-connected communication controller comprising a plurality of programming instructions stored in a memory and operating on a processor of a network-connected computing device, and configured to operate an enriched multilayered multimedia communication system to facilitate two-way communication with a plurality of user devices via a network comprising:
an account manager comprising a plurality of programming instructions stored in a memory and operating on a processor of a network-connected computing device, and configured to receive and store user information from the plurality of user devices;
an interactive element registrar comprising a plurality of programming instructions stored in a memory and operating on a processor of a network-connected computing device, and configured to receive a plurality of interactive elements from the plurality of user devices;
an automatic speech recognizer comprising a plurality of programming instructions stored in a memory and operating on a processor of a network-connected computing device, and configured to receive audio input via a user device, and configured to convert at least a portion of the audio input to text data, and configured to look up at least a plurality of interactive elements based at least in part on at least a portion of the text data;
an action registrar comprising a plurality of programming instructions stored in a memory and operating on a processor of a network-connected computing device, and configured to receive a plurality of actions and associated action data from the plurality of user devices;
an association server comprising a plurality of programming instructions stored in a memory and operating on a processor of a network-connected computing device, and configured to associate one or more actions to one or more interactive elements;
a phrase database comprising a plurality of programming instructions stored in a memory and operating on a processor of a network-connected computing device, and configured to store the plurality of interactive elements;
an object database comprising a plurality of programming instructions stored in a memory and operating on a processor of a network-connected computing device, and configured to store the plurality of actions and associated action data; and
a dictionary server comprising a plurality of programming instructions stored in a memory and operating on a processor of a network-connected computing device, and configured to store and provide at least a plurality of dictionary words stored by users and a plurality of functional associations, the functional associations comprising at least a plurality of programming instructions configured to produce an effect within or upon a software application or hardware device, and further configured to direct an integration server to send at least a portion of the plurality of functional associations to at least a portion of the plurality of clients.

2. The system of claim 1, wherein the integration server receives at least a plurality of user activity information from at least a portion of the plurality of clients, the user activity information comprising at least a plurality of user messaging activity, and the dictionary server selects at least a portion of the functional associations based at least in part on at least a portion of the user activity information.

3. The system of claim 2, wherein the user messaging activity comprises at least a plurality of text-based words.

4. The system of claim 2, wherein the user activity information further comprises at least a plurality of user-specific identifiable information.

5. The system of claim 4, wherein the account manager compares at least a portion of the user-specific identifiable information to at least a portion of a plurality of stored user-specific information.

6. The system of claim 1, wherein the plurality of clients comprises at least a plurality of user devices communicating via a network.

7. A method for providing enriched multilayered multimedia communications interactive element propagation, comprising the steps of:
configuring, at a dictionary server comprising a plurality of programming instructions stored in a memory and operating on a processor of a network-connected computing device, and configured to store and provide at least a plurality of dictionary words stored by users and a plurality of functional associations, the functional associations comprising at least a plurality of programming instructions configured to produce an effect within or upon a software application or hardware device, and further configured to direct an integration server to send at least a portion of the plurality of functional associations to at least a portion of the plurality of clients, a plurality of dictionary words;
configuring a plurality of functional associations;
linking at least a portion of the plurality of dictionary words with at least a portion of the plurality of functional associations;
receiving, at an integration server comprising a plurality of programming instructions stored in a memory and operating on a processor of a network-connected computing device, and configured to operate a plurality of software or hardware-based communication interfaces to facilitate two-way communication with a plurality of clients via a network, a plurality of user activity information from a client via a network;
identifying a plurality of dictionary words within at least a portion of the plurality of user activity information; and
sending at least a functional association to the client via a network, the functional association being selected based at least in part on a configured link between the functional association and at least a portion of the plurality of identified dictionary words.
